(19) United States
(12) Patent Application Publication
(10) Pub. No.: US 2009/0095076 A1
(43) Pub. Date: Apr. 16, 2009

(54) Acceleration Sensor Device and Sensor Apparatus

(76) Inventor: Yasuhiro Tamura, Tokyo (JP)

Correspondence Address: Ralph A. Dowell of DOWELL & DOWELL P.C., 2111 Eisenhower Ave, Suite 406, Alexandria, VA, 22314, US

(21) Appl. No.: 11/990,501

(22) PCT Filed: Aug. 18, 2005
(86) PCT No.: PCT/JP2005/015096

§ 371 Date: Feb. 15, 2008

(51) Int. Cl. G01P 3/00

(52) U.S. Cl. 73/497

(57) ABSTRACT

An acceleration sensor device includes: a substrate; and an acceleration sensor chip including an acceleration sensor element which has a weight portion arranged to swing according to acceleration applied, and a seating portion which supports the acceleration sensor element, the acceleration sensor chip being mounted on the substrate. A cushion member is interposed between the seating portion and the substrate, which absorbs any thermal stress occurring when the seating portion and the substrate undergo thermal expansion or thermal contraction.

### TECHNICAL FIELD

The present invention relates to an acceleration sensor device for detecting acceleration and a sensor apparatus comprising a plurality of sensors.

### BACKGROUND TECHNOLOGY

Conventionally, acceleration sensors have been used in car-mounted air bag systems and the like. With the miniaturization and reduction in power consumption of acceleration sensors in recent years, small information terminals such as cellular phones have also started implementing acceleration sensors.

Various methods have been proposed for the principle of operation of the acceleration sensors, such as a piezoresistive acceleration sensor that utilizes a piezoresistive effect. The piezoresistive acceleration sensor has a structure composed of a weight portion, a beam portion for supporting the weight portion, and a frame body for supporting the beam portion, which are formed by etching a silicon substrate. The beam portion is provided with a piezo resistor the resistance of which varies when undergoing a stress. The acceleration sensor device is integrally jointed to the top of a seating which is made of glass, thereby constituting an acceleration sensor chip. When the acceleration sensor chip undergoes acceleration, the inertial force of the weight portion warps the beam portion causing a change in the resistance of the piezo resistor, so that an electric signal corresponding to the acceleration can be taken out.

If such an acceleration sensor chip is mounted on a substrate that is made of a glass epoxy or other materials having a greater coefficient of thermal expansion than that of silicon, thermal expansion or thermal contraction due to temperature variations in the external environment creates a thermal stress, which can distort the acceleration sensor chip with deterioration in the output characteristic. Patent Document 1 discloses an example where an acceleration sensor chip is mounted on a ceramic substrate which has a coefficient of thermal expansion similar to that of silicon.

[Patent Document 1] Japanese Patent Application Laid-Open No. Hei 10-12805.

### DISCLOSURE OF THE INVENTION

### Problems to be Solved by the Invention

When the substrate is limited to materials having a coefficient of thermal expansion similar to that of silicon, however, the poor flexibility of substrate selection may hinder the selection of substrates of lower prices. In particular, hybrid sensor apparatuses having a plurality of sensors such as an acceleration sensor, a magnetic sensor, and a temperature sensor integrated therein have been proposed recently. Limiting the substrate type for the sake of the acceleration sensor alone has thus caused the problem of inhibiting price reduction of these sensor apparatuses.

The present invention has been achieved in view of the foregoing circumstances, and an objective thereof is to provide an acceleration sensor device and a sensor apparatus which can suppress deterioration in the output characteristic due to thermal expansion or thermal contraction.

### Means for Solving the Problems

To solve the foregoing problem, an acceleration sensor device according to one embodiment of the present invention includes: a substrate; and an acceleration sensor chip including an acceleration sensor element which has a weight portion arranged to swing according to acceleration applied, and a seating portion which supports the acceleration sensor element. A cushion member is interposed between the seating portion and the substrate, which absorbs any thermal stress occurring when the seating portion and the substrate undergo thermal expansion or thermal contraction.

According to this embodiment, the cushion member interposed between the seating portion and the substrate absorbs thermal stresses resulting from thermal expansion or thermal contraction. Even if the seating portion of the acceleration sensor chip and the substrate have different coefficients of thermal expansion, the cushion member can suppress distortion of the acceleration sensor chip and suppress deterioration in the output characteristic. This increases the flexibility in selecting the substrate.

The cushion member may have approximately the same coefficient of thermal expansion as the seating portion. The cushion member and the seating portion having approximately the same coefficients of thermal expansion can absorb thermal stresses favorably and avoid deterioration of the output characteristic.

The substrate may be a glass epoxy substrate. The seating portion may be made of silicon or glass having a coefficient of thermal expansion similar to that of silicon. The cushion member may be made of silicon or glass having a coefficient of thermal expansion similar to that of silicon. Even when using a glass epoxy substrate which has a coefficient of thermal expansion ten or more times that of silicon, the cushion member made of silicon or glass having a coefficient of thermal expansion similar to that of silicon can absorb thermal stresses and avoid deterioration of the output characteristic. Glass epoxy substrates are less expensive than ceramic substrates, and can thus reduce the manufacturing cost of the acceleration sensor device.

The seating portion and the cushion member may be fixed together with a silicon adhesive. The cushion member and the substrate may be fixed together with a silicon adhesive. This can suppress the occurrence of thermal stresses due to thermal expansion or thermal contraction of the adhesives, and favorably further suppress the deterioration of the output characteristic.

Another embodiment of the present invention is a sensor apparatus. This sensor apparatus includes: the foregoing acceleration sensor device; a magnetic sensor for detecting magnetism; and a pressure sensor for detecting pressure. In this instance, the plurality of sensors can be integrated into the sensor apparatus. This increases the flexibility in selecting the substrate, thereby making it possible to select less expensive substrates and reduce the manufacturing cost of the sensor apparatus.

It should be appreciated that arbitrary combinations of the foregoing constituting elements, and implementations of the invention in the form of methods, systems, and the like are also applicable as embodiments of the present invention.

### EFFECTS OF THE INVENTION

According to the present invention, it is possible to provide an acceleration sensor device and a sensor apparatus with reduced deterioration in the output characteristic due to thermal expansion or thermal contraction.

### BRIEF DESCRIPTION OF THE DRAWINGS

FIG. 1 is a cross-sectional view of an acceleration sensor device according to an embodiment of the present invention;

FIG. 2 is a perspective-view of an acceleration sensor chip;

FIG. 3(a) is a diagram showing a sensor apparatus, or a plurality of types of sensors packaged in one;

FIG. 3(b) is a cross-sectional view of the sensor apparatus shown in FIG. 3(a), taken along the line B-B′.

### DESCRIPTION OF REFERENCE NUMERALS

10 acceleration sensor device, 12 substrate, 14 cap, 15 package, 16 acceleration sensor element, 18 seating portion, 20 acceleration sensor chip, 26 beam portion, 28 weight portion, 30 frame body, 32 bonding pad, 34 wire, 38 solder ball, 40 signal processing chip, 42 piezoresistive element, 44, 48, 64 adhesive, 46 cushion member, 50 magnetic sensor chip, 60 pressure sensor chip, and 100 hybrid sensor apparatus.

### THE BEST MODE FOR CARRYING OUT THE INVENTION

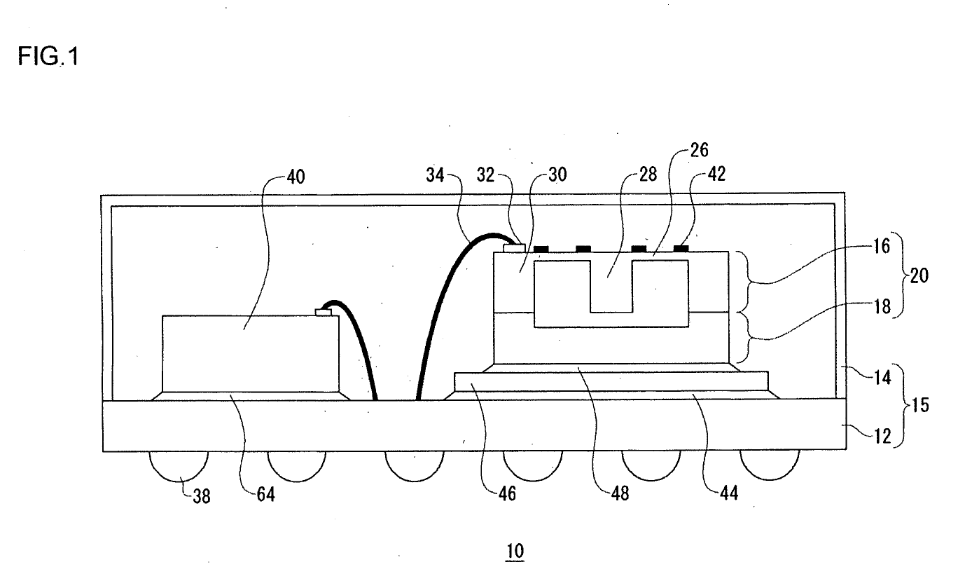

FIG. 1 is a cross-sectional view of an acceleration sensor device 10 according to an embodiment of the present invention. The acceleration sensor device 10 is an acceleration sensor device of BGA (Ball Grid Array) type. The acceleration sensor device 10 is mounted on a small information terminal such as a cellular phone, for example, and is used for applications such as detecting acceleration in three axial directions to detect the tilt of the small information terminal.

As shown in FIG. 1, the acceleration sensor device 10 has an acceleration sensor chip 20 and a signal processing chip 40 which are implemented in a package 15 composed of a substrate 12 and a cap 14.

The substrate 12 is provided with not-shown circuit wiring on the top and in the interior of the substrate. The bottom of the substrate 12 is provided with a plurality of solder balls 38 which function as external terminals for inputting and outputting an acceleration signal and a power supply voltage. The substrate 12 may be a glass epoxy substrate.

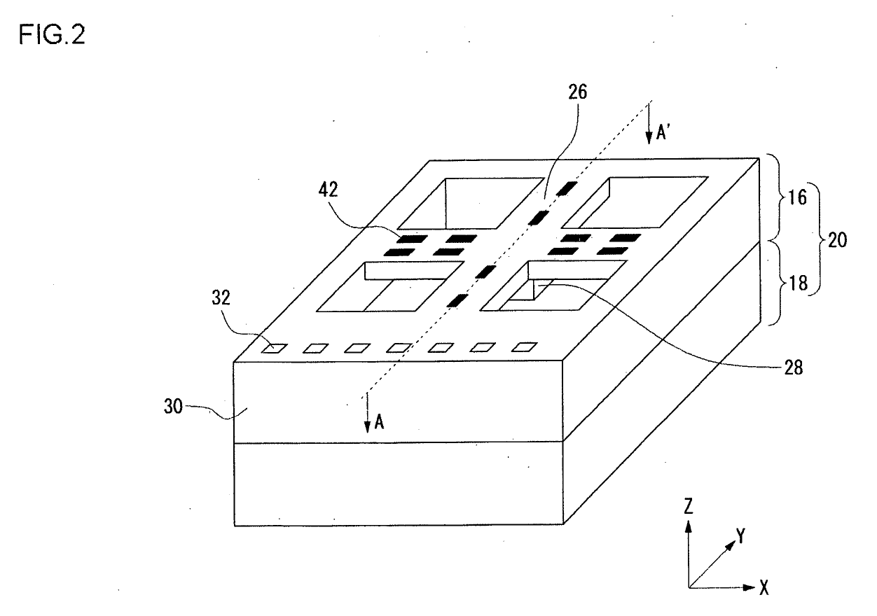

FIG. 2 is a perspective view of the acceleration sensor chip 20. The acceleration sensor chip 20 shown in FIG. 1 is the cross section taken along the line A-A′ of FIG. 2. The acceleration sensor chip 20 includes an element for detecting acceleration, or an acceleration sensor element 16, and a seating portion 18 which supports the acceleration sensor element 16.

The acceleration sensor element 16 has a structure composed of a frame body 30, beam portions 26, and a weight portion 28 which are formed by dry etching a silicon base material. Piezoresistive elements 42 are formed on the beam portions 26.

The frame body 30 is the base member of the acceleration sensor chip 20, and is formed in a rectangular shape. The beam portions 26 are extended from the four internal surfaces of the frame body 30 toward the inside of the frame body 30, respectively, and cross near the center of the opening of the frame body 30. The frame body 30 has a thickness of approximately 250 μm.

As shown in FIG. 2, the beam portions 26 are formed so that their top surfaces are flush with the top surface of the frame body 30. The beam portions 26 may be formed with their top surfaces spaced apart from the top surface of the frame body 30. That is, the beam portions 26 may be extended from intermediate positions between the top surface and bottom surface of the internal surfaces of the frame body 30. The beam portions 26 are formed in a small thickness so as to have elasticity, and are desirably formed to be approximately 5 μm.

The weight portion 28 is intended to swing in accordance with the magnitude of acceleration applied, thereby changing the amounts of warping of the beam portions 26. The weight portion 28 is formed to extend downward from the bottom of the beam portions 26 at the area where the four beam portions 26 intersect. The weight portion 28 is a block member of rectangular prismatic shape.

The piezoresistive elements 42 are intended to convert the amounts of warping of the deformed beam portions 26 into electric signals. The piezoresistive elements 42 are formed on the surfaces of the beam portions 26. Four elements per axis, or a total of twelve elements for the three axes, are arranged at the positions of the beam portions 26 where stresses concentrate on the most. The signals are proportional to acceleration, and the four elements on each axis constitute a Wheatstone bridge circuit to detect stress-based changes in resistance in the form of voltage variations. The acceleration signals detected are output from bonding pads 32.

The seating portion 18 is made of silicon, or glass having a coefficient of thermal expansion similar to that of silicon. In this instance, silicon has a coefficient of thermal expansion of 3×10⁻⁶/° C. The glass having a coefficient of thermal expansion similar to that of silicon refers to glass having a coefficient of thermal expansion of 2.5 to 4.5×10⁻⁶/° C. The seating portion 18 is a flat plate of rectangular shape. As shown in FIG. 1, it is partly recessed in the top surface so as to secure space for the weight portion 28 to swing. The seating portion 18 is joined to the acceleration sensor device 16 by anodic bonding at the peripheral areas of the opening of the frame body 30. The seating portion 18 has a thickness of approximately 250 μm.

The signal processing chip 40 shown in FIG. 1 integrates processing circuits such as a circuit for performing arithmetic processing on the acceleration signals in the respective axial directions, obtained from the Wheatstone bridges of the piezoresistive elements 42. Although omitted from the drawings, the signal processing chip 40 may also include an EEPROM or other memory cell chips for storing data necessary for arithmetic processing.

The acceleration sensor chip 20 and the signal processing chip 40 are mounted on the substrate 12, and are electrically connected with wires 34 and not-shown wiring formed in the substrate 12. The acceleration sensor chip 20 and the signal processing chip 40 are sealed with the cap 14.

As shown in FIG. 1, the signal processing chip 40 is fixed directly to the substrate 14 with an adhesive 64. For the acceleration sensor chip 20, a cushion member 46 is interposed between the seating portion 18 and the substrate 12 to absorb thermal stresses occurring when the seating portion 18 and the substrate 12 undergo thermal expansion or thermal contraction. The cushion member 46 is a flat plate of rectangular shape. The top surface of the cushion member 46 is formed to be at least the same size as the bottom surface of the seating portion 18, and is preferably larger than the bottom surface of the seating portion 18. The cushion member 46 has a thickness of approximately 100 μm. The substrate 12 and the cushion member 46 are fixed together with an adhesive 44, and the cushion member 46 and the seating portion 18 are fixed together with an adhesive 48.

If the seating portion 18 of the acceleration sensor chip 20 is fixed directly to the substrate 12 without the provision of the cushion member 46, the substrate 12 and the seating portion 18 undergo thermal expansion or thermal contraction depending on temperature changes in the external environment. For example, if a glass epoxy substrate is used as the substrate 12, a thermal stress can occur between the substrate 12 and the seating portion 18 since glass epoxy has a coefficient of thermal expansion of 50 to 70×10⁻⁶/° C., which is ten or more times that of silicon. When the seating portion 18 is distorted by this thermal stress, the beam portions 26 of the acceleration sensor element 16, joined to the seating portion 18, are warped and accordingly change the resistances of the piezoresistive elements 42. This deteriorates the output characteristic of the acceleration sensor device 10.

In the acceleration sensor device 10 according to the present embodiment, the cushion member 46 interposed between the seating portion 18 and the substrate 12 absorbs thermal stresses and suppresses distortion of the seating portion 18. This can consequently suppress warpage of the beam portions 26, and suppress resistance variations in the piezoresistive elements 42. It is therefore possible to avoid deterioration of the output characteristic of the acceleration sensor device 10.

Conventionally, in order to avoid deterioration of the output characteristic due to thermal stresses, it has been necessary to select a substrate that has a coefficient of thermal expansion similar to that of the acceleration sensor chip 20. For example, if the acceleration sensor chip 20 is made of silicon and glass, a ceramic substrate having a coefficient of thermal expansion similar to that of silicon has been used. With the acceleration sensor device 10 according to the present embodiment, the provision of the cushion member 46 can suppress distortion of the acceleration sensor chip 20 even if the acceleration sensor chip 20 and the substrate 12 have different coefficients of thermal expansion. This increases the flexibility in selecting the substrate 12. For example, glass epoxy substrates are less expensive than ceramic substrates, and can thus reduce the manufacturing cost of the acceleration sensor device 10.

The cushion member 46 preferably has approximately the same coefficient of thermal expansion as that of the seating portion 18. For example, when the seating portion 18 is made of silicon or glass having a coefficient of thermal expansion similar to that of silicon, the cushion member 46 is also preferably made of silicon or glass having a coefficient of thermal expansion similar to that of silicon. If the cushion member 46 and the seating portion 18 have different coefficients of thermal expansion, thermal expansion or thermal contraction of the cushion member 46 itself may cause distortion of the seating portion 18. The cushion member 46 and the seating portion 18 having approximately the same coefficients of thermal expansion can absorb thermal stresses favorably and avoid deterioration in the output characteristic. When using silicon for the cushion member 46, the cushion member 46 can be formed by dicing a silicon mirror wafer into a predetermined shape.

It is also preferable that the seating portion 18 and the cushion member 46 are fixed together with a silicon adhesive, and the cushion member 46 and the substrate 12 are fixed together with a silicon adhesive. For example, if epoxy adhesives are used as the adhesives 44 and 48, thermal expansion or thermal contraction of the adhesives may cause deterioration of the output characteristic of the acceleration sensor device 10. The use of silicon adhesives makes it possible to suppress the deterioration of the output characteristic due to the effect of the adhesives. It should be appreciated that the signal processing chip 40 has no portion that varies mechanically, and thus requires no cushion member. The type of the adhesive 64 is not limited, either.

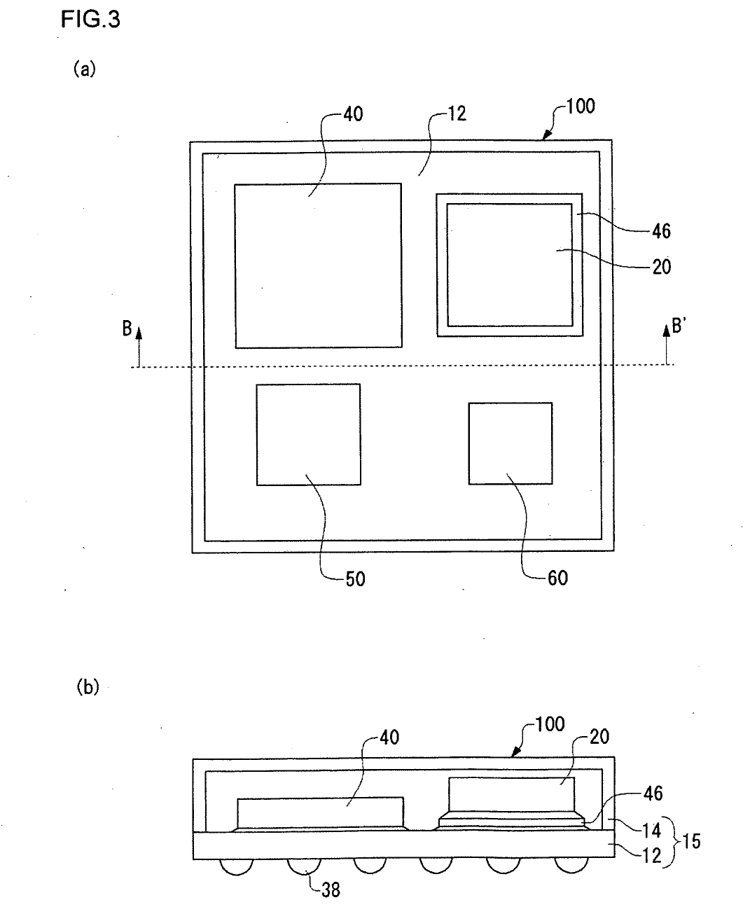

FIG. 3(a) is a diagram showing a hybrid sensor apparatus 100 which has a plurality of types of sensors packaged in one. FIG. 3(b) is a cross-sectional view of the hybrid sensor apparatus 100 shown in FIG. 3(a), taken along the line B-B′. The hybrid sensor apparatus 100 includes an acceleration sensor chip 20, a magnetic sensor chip 50 for detecting geomagnetism, a pressure sensor chip 60 for detecting pressure, and a signal processing chip 40 for processing signals output from these sensors.

The hybrid sensor apparatus 100 is mounted on a small information terminal, for example. The individual sensors can cooperate to perform sensing, for example, such that the signal processing chip 40 corrects an azimuth angle measured by the magnetic sensor chip 50 with a tilt angle measured by the acceleration sensor chip 20. Since the hybrid sensor apparatus 100 has the plurality of sensors packaged in one, the hybrid sensor apparatus 100 can be achieved in small size. It should be appreciated that wires for establishing electric connection between the individual chips are omitted from FIGS. 3(a) and 3(b).

Even in the hybrid sensor apparatus 100, a cushion member 46 is interposed between the substrate 12 and the acceleration sensor chip 20 in order to suppress deterioration of the output characteristic due to temperature variations in the external environment. Meanwhile, the signal processing chip 40, the magnetic sensor chip 50, and the like have no part that varies mechanically, and thus are fixed directly to the substrate 12 with an adhesive.

In conventional sensor apparatuses that contain an acceleration sensor device, the substrate of the entire sensor apparatus has been made of ceramic or other materials having a coefficient of thermal expansion similar to that of silicon so that the acceleration sensor device is prevented from deteriorating in the output characteristic. This has meant low flexibility of substrate selection.

In the hybrid sensor apparatus 100 shown in FIGS. 3(a) and 3(b), the cushion member 46 absorbs thermal stresses occurring between the substrate 12 and the seating portion of the acceleration sensor chip 20. This increases the flexibility in selecting the substrate 12, so that glass epoxy and other materials having coefficients of thermal expansion higher than that of silicon can also be used for the substrate. As mentioned above, glass epoxy substrates are less expensive than ceramic substrates, and can thus reduce the manufacturing cost of the hybrid sensor device 100.

Up to this point, the present invention has been described in conjunction with the embodiment thereof. This embodiment has been given solely by way of illustration. It will be understood by those skilled in the art that various modifications may be made to combinations of the foregoing constituting elements and processes, and all such modifications are also intended to fall within the scope of the present invention.

### INDUSTRIAL APPLICABILITY

The preset invention is applicable to fields pertaining to acceleration sensor devices and sensor apparatuses.

1. An acceleration sensor device comprising:
a substrate; and
an acceleration sensor chip including an acceleration sensor element which has a weight portion arranged to swing according to acceleration applied, and a seating portion which supports the acceleration sensor element, wherein
a cushion member is interposed between the seating portion and the substrate, which absorbs any thermal stress occurring when the seating portion and the substrate undergo thermal expansion or thermal contraction.

2. An acceleration sensor device according to claim 1, wherein the cushion member has approximately the same coefficient of thermal expansion as the seating portion.

3. An acceleration sensor device according to claim 1, wherein:
the substrate is a glass epoxy substrate;
the seating portion is made of silicon or glass having a coefficient of thermal expansion similar to that of silicon; and
the cushion member is made of silicon or glass having a coefficient of thermal expansion similar to that of silicon.

4. An acceleration sensor device according to claim 3, wherein:
the seating portion and the cushion member are fixed together with a silicon adhesive; and
the cushion member and the substrate are fixed together with a silicon adhesive.

5. A sensor apparatus comprising:
the acceleration sensor device according to claim 1;
a magnetic sensor for detecting magnetism; and
a pressure sensor for detecting pressure.

6. An acceleration sensor device according to claim 2, wherein:
the substrate is a glass epoxy substrate;
the seating portion is made of silicon or glass having a coefficient of thermal expansion similar to that of silicon; and
the cushion member is made of silicon or glass having a coefficient of thermal expansion similar to that of silicon.

7. A sensor apparatus comprising:
the acceleration sensor device according claim 2;
a magnetic sensor for detecting magnetism; and
a pressure sensor for detecting pressure.
